(19) United States
(12) Patent Application Publication
(10) Pub. No.: US 2023/0159325 A1
(43) Pub. Date: May 25, 2023

(54) A SYSTEM AND METHOD FOR PRODUCING HYDROGEN ON DEMAND

(71) Applicant: ELEMENT 1 TECHNOLOGIES, LLC, Winter Garden, FL (US)

(72) Inventor: Russell L. Case, JR., Oviedo, FL (US)

(21) Appl. No.: 17/924,479

(22) PCT Filed: May 14, 2021
(86) PCT No.: PCT/US2021/032378

§ 371 Date: Nov. 10, 2022

Related U.S. Application Data
(60) Provisional application No. 63/024,630, filed on May 14, 2020.

(51) Int. Cl. C01B 3/08

(52) U.S. Cl. CPC C01B 3/08; C01B 2203/169; C01B 2203/1628; C01B 2203/066

(57) ABSTRACT

A method for producing hydrogen by controlling an exothermic reaction provides a metal, input to a reaction chamber, at a first flow rate. An acid is provided and input to the reaction chamber at a second flow rate. The combination of the metal and acid produces hydrogen under pressure in the reaction chamber. Hydrogen is output from the reaction chamber at a first pressure and at a third flow rate. The first pressure and the third flow rate are determined. Each of the first flow rate of the metal and the second flow rate of the acid are controlled as a function of the first pressure and third flow rate.

### CROSS-REFERENCES TO RELATED APPLICATION

This application claims the benefit of U.S. Provisional Patent Application Ser. No. 63/024,630, filed May 14, 2020, the entireties of which are incorporated by reference herein as if fully set forth.

### BACKGROUND OF THE INVENTION

The present invention is directed to a system and method for producing hydrogen, and more specifically for the production of hydrogen when needed and where needed, on demand, to supply a hydrogen fuel cell utilizing simplified equipment and processes.

As a result of climate change and interest in alternative fuels, many of the world's largest logistics suppliers are committed to significantly reducing their carbon emissions from fossil fuels used in internal combustion engines. From forklifts to long-haul trucks, these companies have publicly announced their plans to “go green” by converting their fleets to green power. Green hydrogen is a promising, and desired, power source as it may be produced without using hydrocarbons in the production processes. Today, the challenges for green hydrogen as a solution have been the costs of production, transportation and storage.

Hydrogen is the most common element in the universe, comprising approximately 75% of all the mass in the universe, primarily found in combination with other elements, forming more complex molecules. These molecules include water and hydrocarbons. However, in order for hydrogen to be useful as a fuel, or energy carrier, hydrogen must be extracted from a more complex molecule.

There is an urgent need to bring to the world viable alternative fuel-powered vehicles. Consequently, to make alternative vehicles viable, there is a need to build refueling infrastructure, to power these vehicles. It is believed there will soon be many thousands more hydrogen powered vehicles ready to travel the roads, but only to be restricted to a 200-mile radius of the nearest refueling station. For reasons discussed below the manufacture of hydrogen, particularly green manufacture, has required complex structures and processes, as a result there are currently only 34 hydrogen refueling stations in the US; all of which are located in California.

There are three ways in which to liberate the energy carried by hydrogen; each currently having their shortcomings. The first is to compress hydrogen in the presence of an immense gravitational field, fusing the hydrogen to create helium. This nuclear fusion occurs in our sun and in all the stars of the universe. This fusion, and subsequent reactions, create all the elements.

This process releases immense amounts of energy, and will supplant the hydrogen economy but requires expensive complex, large scale systems to control this reaction. The second is to combust it—essentially by burning. One mass unit of hydrogen releases approximately three times more energy than an equivalent mass of gasoline. It is one of the most energy dense fuels known to man, but such combustion requires control of an invisible flame. The third method is to combine hydrogen with oxygen through redox reactions in a fuel cell, directly producing an electric current and water as the reactant. However, as currently practiced none of these methods is particularly mobile, even if more economical.

The future of hydrogen as a fuel depends on developing large scale utilization and infrastructure and innovation of the infrastructure which addresses each of these shortcomings. If accomplished it is believed that hydrogen as a mobile energy carrier will dominate its use.

Currently hydrogen powered vehicles use stored hydrogen gas and a fuel cell to generate electricity to drive electric motors, converting chemical energy to electrical energy and finally to mechanical energy. The problem lies in the fact that, as known in the art, in order to store useful quantities of hydrogen gas, it must be pressurized. The pressures required range from 10,000 pounds per square inch (psi) to over 40,000 psi. While hydrogen is highly combustible (explosive), the storage tanks are generally safe and an explosion hazard has a low probability.

However, the fueling process suffers from the disadvantage that the transfer of hydrogen gas at pressures ranging from 10,000 psi to 40,000 psi, the equipment and connectors are complex and difficult to handle. The average motorist is not prepared to receive the safety and operations training required to connect, disconnect, and manage high pressure gas equipment. Leaked hydrogen gas, while not explosive in an open environment, is highly combustible and presents a significant danger in that the gas itself, and the combustion, are invisible.

The infrastructure to distribute high pressure hydrogen is similarly complex and very expensive providing an economic disincentive to build the infrastructure. One kilogram of hydrogen is roughly equivalent to one and a half gallons of gasoline in energy utilization. This disparity, which is different than the 3-tol energy carrying capacity, is primarily due to the equipment and the methods of releasing the energy. At $2 per gallon for gasoline, a kilogram of hydrogen must be delivered to the motorist at $3 per kilogram just to make the cost equivalency. In the few prior art hydrogen fueling stations in the country, hydrogen is selling for $16 per kilogram and at that is highly subsidized by the government.

The most widely known prior art method of producing hydrogen is to extract it from water through the process of electrolysis. This method is used both on a small scale and commercially.

2H₂O→2H₂+O₂

However, producing hydrogen gas with over 99.9% purity is an expensive method requiring significant amounts of energy. Furthermore the method is endothermic; it requires an outside energy source to perform the method.

The most commercially viable prior art method of producing hydrogen at an industrial scale is steam reforming of methane. This is typically a three-step process.

The first step is to react methane gas with high temperature steam (over 1100° C.) to produce what is called “synthesis gas” in the industry. The reaction occurs using nickel-based catalysts. The reaction equation is:

CH₄+H₂O→CO+3H₂

The next step is to pass the synthesis gas (mixture of carbon monoxide, CO, and hydrogen gas, H₂) with additional steam over another catalyst, typically Fe₂O₃ or CoO, at about 400° C., called the water-gas shift reaction. This converts the carbon monoxide gas to carbon dioxide gas. The hydrogen gas is unaffected. The equation is:

CO+H₂O→CO₂+H₂

While this reaction alone is exothermic, it relies on the fact that the water is already heated, thus being an overall consumer of energy. The gas mixture now consists of carbon dioxide and hydrogen.

The third step is to remove the carbon dioxide from the gas mixture by passing it through a lime-water, Ca(OH)₂, or other “base” solutions, converting the carbon dioxide to a carbonate, which remains in the aqueous phase. This equation is:

CO₂±H₂Ca(OH)₂→CaCO₃+H₂O+H₂

Hydrogen produced by this method is about 98% pure. Higher purity hydrogen is created by passing the gas mixture through filters of zeolite. This process is expensive, time consuming and requires numerous steps; requiring some level of skill not available on a wide basis to control the process. It also releases carbon pollutants as a byproduct.

Neither of these prior art methods is particularly “mobile” in that it is not very practical to install either one of these production system on a vehicle, nor is the most common method very “green” in its byproducts.

Currently, the prior art hydrogen infrastructure is capable of producing hydrogen gas as fast and as efficiently as possible, but only at a centralized fixed location, requiring transport of the hydrogen to a refueling station. However, as seen from the above, there is no feasible prior art solution for widespread positioning of the hydrogen production equipment onsite at a refueling location, eliminating the cost time and potential danger associated with pressurized, cooled hydrogen.

In summary, the prior art methods suffer from the disadvantage that the production at scale is not commercially viable because the end product is not equal to, or less than, the cost of equivalent fossil fuels. Prior art storage of hydrogen for vehicles consists of tanks pressurized from 10,000 to 40,000 psi which brings significant hardware infrastructure and safety concerns. The reactants and their products are not environmentally safe. The prior art methods require significant additional energy to be supplied; essentially limiting the reaction types to exothermic and catalytic, ruling out fixed site production concurrent with fossil fuel-based production.

In the case of steam reforming the reactants and products are difficult to transport through current infrastructure particularly with regulatory concerns. Accordingly a system and or method for producing hydrogen on demand which overcomes the shortcomings of the prior art is desired.

### SUMMARY OF THE INVENTION

A method for producing hydrogen by controlling an exothermic reaction provides a metal, input to a reaction chamber, at a first flow rate. An acid is provided and input to the reaction chamber at a second flow rate. The combination of the metal and acid produces hydrogen under pressure in the reaction chamber. Hydrogen is output from the reaction chamber at a first pressure and at a third flow rate. The first pressure and the third flow rate are determined. Each of the first flow rate of the metal and the second flow rate of the acid are controlled as a function of the first pressure and third flow rate.

### BRIEF DESCRIPTION OF THE DRAWINGS

The features and advantages of the present invention will become more readily apparent from the following detailed description of the invention in which like elements are labeled similarly and in which:

FIG. 1 is an operational diagram of the method for producing hydrogen in accordance with the invention;

FIG. 2 is a perspective view of an exemplary device for producing hydrogen in accordance with a first embodiment of the invention;

FIG. 3 is a perspective view of an exemplary device for producing hydrogen in accordance with a second embodiment of the invention;

FIG. 4 is a perspective view of an exemplary cartridge in accordance with the invention;

FIG. 5 is a top perspective view of a solid fuel filter in accordance with the invention;

FIG. 6 is a bottom perspective view of a solid fuel filter in accordance with the invention; and

FIG. 7 is a sectional view taken along line 7-7.

### DETAILED DESCRIPTION OF THE PREFERRED EMBODIMENTS

The present invention provides a system and method for controlling an exothermic reaction to produce hydrogen. A number of exothermic reactions were considered for use with the invention. The invention embodies the process of managing any acid (a proton donor or acceptor of an electron pair in reactions) which reacts with a metal on an exothermic basis to form hydrogen gas. Preferably the metal has an atomic number less than or equal to 26.

Other reactions within the scope of the invention include metal hydrides reacting with water or other compounds.

Metal—Acids

Metal+Acid→Metal Compound+Hydrogen Gas

Lithium—Water

2Li+2H₂O→2LiOH+H₂

Lithium—Acetic Acid

2Li+2CH₃COOH→2CH₃COOLi+H₂

Lithium—Sulfuric Acid

2Li+H₂SO₄→LiSO₄+H₂

Sodium—Water

2Na+2H₂O→2NaOH+H₂

Magnesium—Acetic Acid

Mg+2CH₃COOH→Mg(CH₃COO)₂+H₂

Magnesium—Hydrochloric Acid

Mg+2HCl→MgCl₂+H₂

Potassium—Water

2K+2H₂O→2KOH+H₂

This reaction produces enough heat to possibly ignite the hydrogen and therefore is not preferred for on demand processing.

Zinc—Hydrochloric Acid

Zn+2HCl→ZnCL₂+H₂

Zinc—Hydrogen Phosphate

3Zn+2H₃PO₄→Zn₃(PO₄)₂+3H₂

Zinc—Sulfuric Acid

Zn+H₂SO₄→ZnSO₄+H₂

Aluminum—Water

This is a complex process and therefore is not desired for on demand processing.

Hydrides

Metal Hydrides and other Hydrides also produce hydrogen, but are generally expensive, thus making them less desirable as a reactant, but depending on economic conditions and availability of the reactants, can be used as fuel components for the subject hydrogen on demand system.

Sodium Hydroxide—Aluminum

2NaOH+2Al+6H₂O→2NaAl(OH)₄+3H₂

Sodium Hydroxide—Silicon

4NaOH+Si→Na₄SiO₄+2H₂

Calcium Hydride

CaH₂+2H₂O→Ca(OH)₂+2H₂

This reaction is not preferred because it is expensive for widespread use.

Sodium Borohydrate

NaBH₄+4H₂O→NaB(OH)₄+4H₂

This reaction is not preferred because it is even more expensive for widespread use.

By way of non limiting embodiment, the preferred embodiment is a system operating to create hydrogen on demand utilizing the magnesium—acetic acid reaction because acetic acid is readily available as a commercially available chemical, as it is primarily used in the food service industry. Magnesium is also readily commercially available, primarily used in the pharmaceutical, and manufacturing industries. The metal and the acid are each a fuel for creating the hydrogen on demand with a process in accordance with the invention.

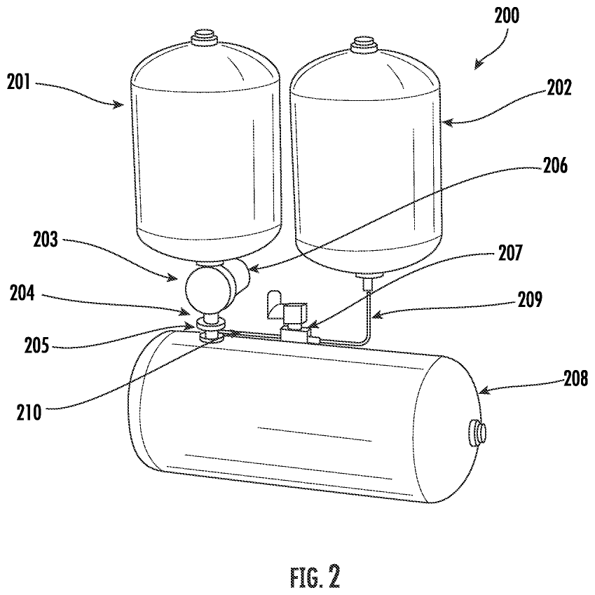

Reference is first made to FIG. 2 which depicts a preferred non-limiting, exemplary embodiment of a hydrogen on demand system, for charging a hydrogen fuel cell constructed in accordance with the invention, generally indicated as 200. System 200 utilizes storage and dispensing tanks 201, 202. In one aspect of the invention, the hydrogen on demand system 200 includes at least two storage and dispensing tanks, 201 and 202, where tank 201 stores and dispenses a solid fuel component, such as a powdered metal, and in a more preferred embodiment, magnesium. Tank 202 stores an acid, such as acetic acid, in this not limiting embodiment in fluid, preferably liquid, form. The solid fuel component may be in the form of dry powder prepared in advance for optimal reaction for the application. It should be noted, that two storage tanks are provided for ease of explanation and that three or more storage tanks for additional fuel components may be provided to create hydrogen in any number of ways, so long as the fuel constituents are metals and acids capable of making an exothermic reaction to form hydrogen.

Each of storage tanks 201 and 202 are in fluid communication with a reaction chamber 208. A solid fuel dispenser 203 is disposed in fluid communication between storage tank 201 and reaction chamber 208. The metal dry powder fuel, in this case magnesium, is conveyed to the reaction chamber 208, in a measured and controlled fashion, via solid fuel dispenser 203, driven by, for example, an electric motor 206. By controlling dispenser 203, the volume and rate of transfer of the reaction fuel can be controlled. The solid fuel component is passed through a separator, 204, downstream of, and in fluid communication, with solid fuel dispenser 203 that reduces the occurrence of vaporized liquid reactants from mixing with dry solid fuel. The solid fuel then passes into a solid-liquid fuel manifold, 205.

The, acid, here a liquid fuel component, is stored and dispensed from tank 202 through an appropriate conveyance, for example, tubes, 209 and 210, under the control of a valve 207, preferably electrically controlled, or any other appropriate fluid control component. The liquid fuel component then enters the solid-liquid fuel manifold, 205, where the solid and liquid fuel components come into contact with each other. As an example exothermic chemical reaction, the fuel components react on contact producing hydrogen gas and a chemical byproduct or reactant. This reaction takes place in the solid-liquid fuel manifold 205 and in the reaction chamber, 208. Hydrogen is collected from the reaction tank 208 and utilized as needed. This hydrogen on demand structure may be enhanced by the method of production of the instant invention. It is well understood in the art, that dispenser 203 and valve 207 are controlled by electronics, or computer.

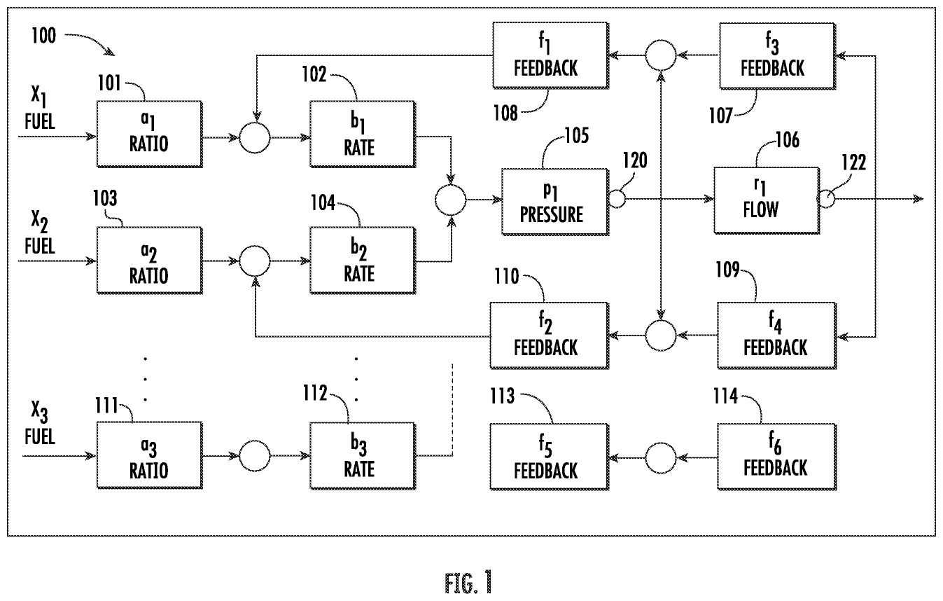

Reference is now made to FIG. 1 wherein an operational diagram of the process flow 100 for hydrogen on demand, within system 200, in accordance with the invention is provided. As shown in step 101, the first fuel component a metal, for example, magnesium, is ratio controlled to optimize the fuel mixture for hydrogen production. A first fuel, x₁, the metal, magnesium, in this example, is operated upon in a process step 101 to control the amount of fuel x₁ delivered from storage tank 201 to reaction chamber of solid liquid manifold 205 on its way to reaction tank 208, as a function of the overall ratio a₁ of fuel x₁ used in the process, as a function of mass, to all fuel components used in the process. By way of example, in the two input example x₁ may represent 25% of the total fuel by mass to be input during a reaction and the second fuel x₂ will be the remaining 75% of the input fuel mass. This is by way of example only as exact ratios will vary depending upon the identity of the fuel components.

In step 102 controlling the flow rate b₁, the rate at which fuel component x₁, the metal in the present example, is also controlled as fuel component x₁ is input to the reaction chamber 208. As is described below the flow rate 102 may also be under the control of feedback inputs from steps 107, 108 corresponding to downstream pressure and flow values respectively.

At substantially the same time, second fuel component x₂, acetic acid, for example, is also ratio controlled in process step 103 for optimal hydrogen production as a function of the overall ratio a₂ of fuel x₂ used in the process, as a function of mass, to all fuel components used in the process. The second fuel component, x₂, is then rate controlled in a process step 104 to provide the proper ratio and flow rate as an input to solid liquid manifold 205.

As discussed above, it is within the scope of the invention to provide third and subsequent “n” fuel components, xₙ, or process reactants such as accelerators, if needed. These fuel components are also ratio controlled (among all fuel constituents) in a process step 111 and rate controlled in a process step 112, or could be substituted with catalysts or other process steps.

The fuel outputs of process steps 102 and 104 are mixed. The output of the mixing is hydrogen gas under pressure p₁ in step 105. This resulting hydrogen under pressure is then flow rate controlled in a process step 106. The pressure p₁ of the hydrogen controlled in step 105 is monitored and input as a feedback to the respective feedback processes 108, 110. Pressure p₁ is sensed in step 105 by a pressure sensor 120 to maintain the pressure at a preferred level and flow rate r₁ of the hydrogen output by system 200 is sensed by a flow meter 122 to control the rate of the exothermic reaction to maintain a desired hydrogen flow rate.

Using only two fuel components as an example, with the understanding that up to “n” fuel components or processes may be combined, the output hydrogen produced is then pressure controlled in process step 105. The flow rates b₁, b₂ can be affected by processing under pressure. Therefore, the rate at which the fuel constituents x₁, and x₂ are processed can be controlled in part as a function of pressure; particularly pressure as a function of the pressure sensed at sensor 120 from process step 105 corresponding to the pressure at which the hydrogen is produced. The pressure value p₁ is fed back through a feedback term step 108 to modify the pressure flowing from dispenser 203, and in turn the flow rate b₁ of the first fuel x₁ component, as a function of the pressure value of the hydrogen output and sensed in step 105, as its rate is controlled in step 102. This is used to optimize the consumption rate of fuel x₁, but also to, for example, ensure back pressure does not interrupt the flow of first fuel x₁. The feedback shown in FIG. 1 may also enhance the flow of the first component fuel x₁, or any other pressure modification desired.

Pressure values sensed at sensor 120 is in put as part of step 108's determination of feedback f₁. Similarly, the pressure feedback term f₂ determined in in step 110 may be used to modulate rate b₂ at which fuel x₂ is consumed in response to the sensed pressure p₁. Pressure feedback terms f₁ and f₂ have values as a function of the reaction being performed and are used in part to control the flow rates b₁, b₂ of each respective fuel constituent x₁, x₂. They may be equal, but do not have to be equal in value.

The hydrogen under pressure value output from process step 105 is then operated upon in process step 106 where the flow rate r₁ of hydrogen is controlled to address the demand A flow meter 122 provided at the flow output of flow rate control process 106 of the produced hydrogen provides input to the feedback processes 107, 109 to maintain the desired flow rate r₁ of the hydrogen. The sensed flow rate r₁ is fed back as respective feedback terms f₃ for the first fuel component in a step 107 and feedback term f₄ of the second fuel component in a step 109. Flow based feedback value f₃ is utilized with pressure based feedback value f₁ to modulate the rate of fuel component flow for x₁ by controlling dispenser 203 in step 102. Simultaneously therewith, or asynchronously, flow rate feedback value f₄ is utilized with pressure feedback value f₂ to modulate the rate of fuel component flow for x₂ by controlling dispenser 207 in step 104 to control the flow of hydrogen. Similarly, feedback values fₙ output as a result of respective output steps 113 and 114 modify third and subsequent “n” fuel components xₙ. As a result the hydrogen is output from system 200 at a pressure p₁ at a flowrate r₁.

At the high-end, at least for commercial use, the fueling hose connected to the generator 100 should avoid being connected to a 10,000 psi hydrogen tank. The jet from a leak at that pressure could be dangerous. Therefore, in the preferred embodiment, the pressure p₁ is kept to 120 psi or less. However, there may be applications where 10,000 or even 40,000 psi could be desired.

As a result of the system and process discussed above, the output hydrogen from step 106 is now controlled for pressure and flow. The process 100 for operating a system 200 as described herein is extremely adaptive as a function of the fuels x₁, x₂, and the use to which the system 200 will be placed. Therefore, each of flow rates and ratios both at the intermediate and final steps may be adjusted as a function of the respective fuel components, xₙ, and the fuel cell. For example many commercial fuel cells operate at an internal pressure of 7.5 psi. Therefore, the internal pressures of each component of system 200 are designed to move the fuel components through system 200 as well as to pressurize the coupled fuel cell to a pressure of 7.5 psi. Therefore, it is often a higher value in the high side of the pressure regulator in process step 105. It is a function of equipment used.

In some applications, it may be necessary to produce hydrogen gas with pressures as high as 10,000 or even 40,000 psi and the parameters for the operating processes in FIG. 1 will be adjusted accordingly. However, as a result of the danger inherent in such high pressure gas transfers, and the need for expensive specialty tanks that can handle such high pressure along with the seals which must be maintained, the pressure regulators and gauges, it is preferred that the pressure output by the system in process step 106 be 120 psi or less.

An example utilization of the system and process of the invention is a fuel cell with the requirements to maintain 51,710.7 Pascals (7.5 pounds per square inch) and 27 liters (7.133 gallons) per minute flow rate at maximum power output. The two feedback components are pressure p₁ and flow rate r₁. The flow rate and pressure must be maintained at the fuel cell input to prevent damage to the proton exchange membrane and provide enough fuel to produce the desired maximum output power. Using a two-component fuel mixture, for example, the ratios are controlled for desired fuel mixture, for example, by mass, volume, or other desired parameter to control the pressure and flow rate of the hydrogen output. As the two components are combined, pressure may be produced exceeding the requirements, but it may be desired to maintain a buffer supply of hydrogen for peak demands or rapidly varying demands, allowing the fuel mixture to remain at an average reaction rate. Additionally, fuel component rates may be adjusted to modulate the gas, vapor, and reactant ratios, as well as the buffer pressure.

In order to facilitate understanding of the hydrogen on demand system that is disclosed herein and to exemplify how hydrogen on demand may be implemented in practice, embodiments will now be described, by way of non-limiting examples, with reference to accompanying drawings.

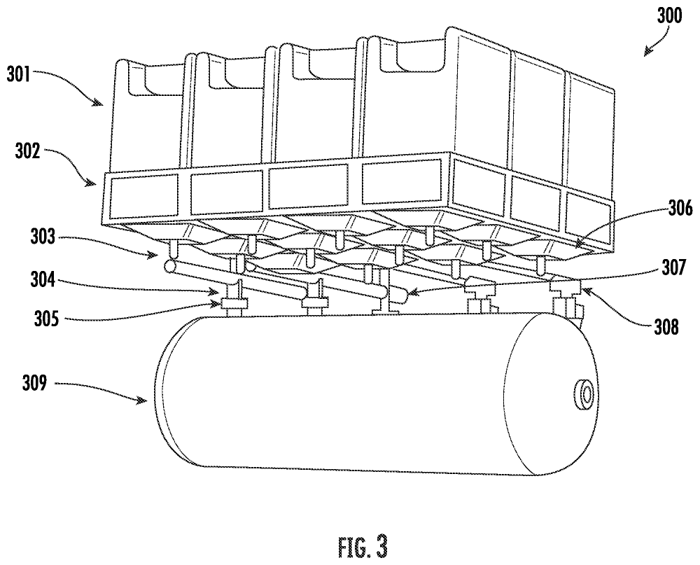

Reference is now made to FIG. 3 in which a hydrogen on demand system, generally indicated as 300, constructed in accordance with a second embodiment of the invention is provided, the primary difference between embodiments is that storage tanks 201, 202 are replaced with replaceable cartridges 301 for conveniently replacing fuel components and capturing reactants for reuse, recycling, and utilization in other products.

One configuration of a cartridge mounting rack 302 is shown in FIG. 3 as a structure to physically guide cartridges 301 into location to mate and seal with, for example, a first fuel component manifold 303. Manifold 303 collects and conveys fuel components contained in the respective containers 301, under the control of an electric motor 307, to a fuel separator 304 that reduces the occurrence of powdered solid fuel, for example, contacting or reacting with reactant vapor and conveys through a fuel manifold 305; the first fuel component to the reaction tank 309.

Similarly, cartridges 301 contain the second fuel component, for example, a liquid, and sealingly fit with a liquid fuel manifold 306 that collects and conveys the second fuel component to a valve 308 for flow control into the reaction tank 309. In reaction tank 309 the fuel components combine to produce hydrogen and a reactant. The number, arrangement, size, and other aspects of the cartridges 301 may be selected for hand replacement, machine replacement, individual replacement, replacement in groups, or any other desirable combination.

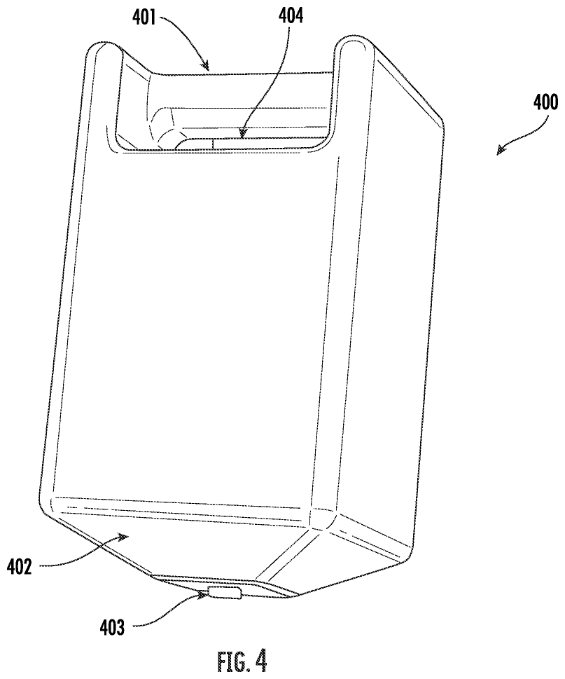

FIG. 4 depicts one non limiting exemplary embodiment of a cartridge 301, having, by way example, a handle 401 for hand carrying, machine attachment, or other means of installing and removing cartridges 301 from a hydrogen on demand system 300. The housing of cartridge 301 includes a sloped bottom surface 402 which facilitates gravity feed of fuel components through mating connector 403, at a bottom of bottom surface 402 into fuel manifolds 303, 306. Pressure relief, reactant capture, or any other desirable function can be accommodated through one or more ports 404 in the cartridge.

Using the magnesium and acetic acid reaction as an example, when the fuel components mix in the fuel manifold 303, 306 and reaction chamber 309, the reaction is forceful enough to produce a reactant vapor of magnesium acetate and unreacted acetic acid with particulate magnesium. With no filter, the vapor reacts with dry powder fuel in the solid fuel dispensing component, creating additional magnesium acetate, which then adheres to surfaces in the solid-liquid manifold, and impedes the free flow of solid fuel.

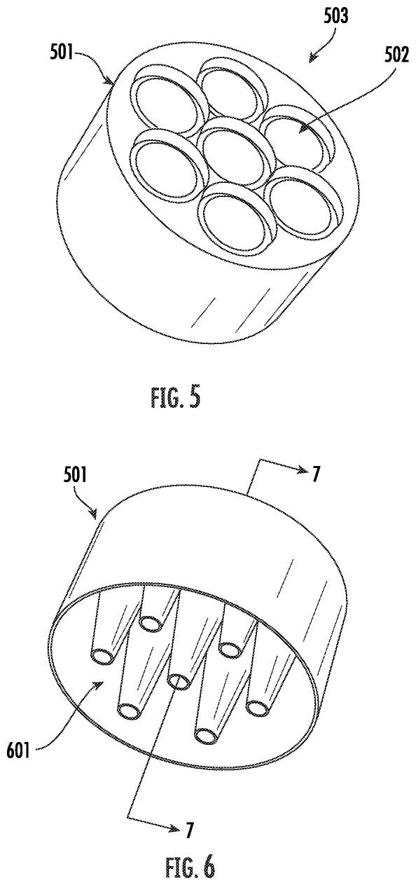

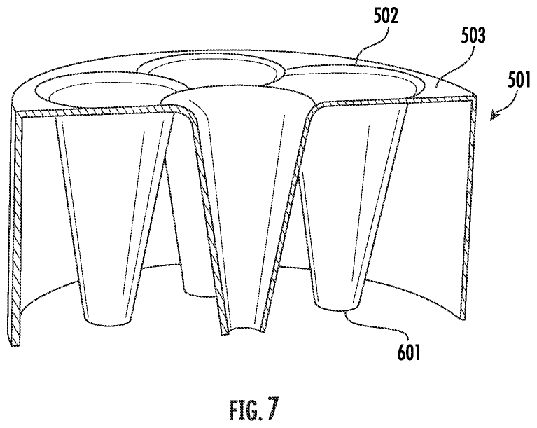

Therefore, in a preferred non-limiting embodiment, to prevent clogging of the solid fuel a back flow reducer 501 is disposed in fuel separator 204 by way of example. As seen in FIGS. 5-7 the back flow reducer 501 has a number of funnel shaped passages with larger openings 502 disposed on a surface 503 of back flow reducer 501 facing towards solid fuel storage tank 201. The sum total area of openings 502 being equal to or greater than the solid fuel dispensing opening. This allows free flow of solid fuel substantially equal to the flow without a solid fuel filter. With the back flow reducer 501 in place, the dry powdered fuel is dispensed and dispersed among the funnel shaped openings and is allowed to free flow into the solid-liquid manifold and the reaction chamber.

Reaction vapor is impeded from entering the solid fuel tank and conveyor by the fact that the surface area 601 of the reaction chamber 203 facing surface of back flow reducer 501 presented to the reaction vapor is a large percentage of the total surface area exposed to the reaction vapor. This is because openings 602 are significantly smaller in diameter than openings 502; providing the funnel shape. Further, by stacking filters, the subsequent percentage of reaction vapor allowed to enter the solid fuel tank and solid fuel conveyor is further reduced. Subsequent filters block enough reaction vapor that solid fuel adherence is essentially eliminated, the remaining fraction of reaction vapor carried into the solid-liquid manifold and reaction chamber with the flow of solid fuel.

A conveyor which relies solely on gravity to feed the solid fuel into reaction chamber 208 can experience a back pressure problem that essentially blows fuel back into solid fuel tank 201. Therefore in a preferred nonlimiting embodiment, in addition to and in conjunction with the back flow reducer 501, a dry solid fuel injector consisting of dry solid fuel maintained at higher pressure than that created in reaction chamber 208, or pressurized as needed, and forced into the solid-liquid manifold 205 and reaction chamber 208, mitigating the impediment of solid fuel flow, can be implemented. The solid fuel injector may be based on pressure inequality, electrostatic, or any other forceful flow of dry solid fuel.

Further, a higher pressure in the solid fuel tank 201 than in the solid-liquid manifold 205 or in the reaction chamber 208, significantly reduces the incursion of reaction vapor or unreacted liquid fuel.

It should also become readily apparent that the inventive method results in hydrogen gas and a metallic compound. As in the case of the preferred embodiment, magnesium and acetic acid, the end product metallic compound, Mg(CH₃COO)₂, may be easily refined to provide the starter magnesium for the hydrogen production process. The same is true for most of the proposed metal-acid reactions. In this way metal fuel components may be recycled, often in situ, to create more and more hydrogen gas providing a reduction in overall cost, need for materials, and even a need for transportation.

It will be recognized that the techniques described herein takes advantage of readily available infrastructure and may be advantageously utilized in other process flows. Additionally, as a result of the system and or process, production at scale becomes commercially viable and equal to, or less than, the cost of equivalent fossil fuels. As a result of the potential low pressure production, the prior art Significant requirement for hardware and safety concerns are less of an issue. The process is environmentally friendly as no carbon is released into the environment; the production process is “green” end-to-end. In the preferred embodiments the reactants must are common and readily available. Based on elemental production in the universe, and percentage of the earth's crust, anything on the periodic chart up to and including the 26^{th} element (iron) can be used. The reactants and products are transportable through current infrastructure with minimal regulatory concerns and any byproducts are able to be captured and recycled products. The inventive hydrogen on demand system is sufficiently light weight as to be used in a mobile environment as it reduces overall vehicle weight. Lastly, the process reaction speed is fast enough to produce useful quantities of hydrogen gas for on-demand applications, such as refueling sites, on-board vehicles or at remote power stations.

1. A method for producing hydrogen by controlling an exothermic reaction comprising the steps of:
providing a metal, the metal being input to a reaction chamber at a first flow rate;
providing an acid, the acid being input to the reaction chamber at a second flow rate;
wherein the combination of the metal and the acid produce hydrogen by exothermic reaction under pressure in the reaction chamber;
outputting the hydrogen from the reaction chamber at a first pressure and a third flow rate;
determining the first pressure;
determining the third flow rate; and
controlling each of the first flow rate and the second flow rate as a function of the first pressure and third flow rate to control the rate of the exothermic reaction.

2. The method for producing hydrogen of claim 1, wherein the first flow rate is a function of ratio of the metal as compared to all fuel components input to the chamber.

3. The method for producing hydrogen of claim 1, where in the second flow rate is a function of the ratio of acid as compared to all fuel components input to the chamber.

4. The method of claim 1, wherein a first feed back value and a second feedback value are determined as a function of the first pressure; the first flow rate being controlled as a function of the first feedback value and the second flow rate being controlled as a function of the second feedback value.

5. The method of claim 1, wherein a third feedback value and a fourth feedback value are determined as a function of the third flowrate; the first flow rate being controlled as a function of the third feedback value and the second flow rate being controlled as a function of the fourth feedback value.

6. The method of claim 5, wherein a third feedback value and a fourth feedback value are determined as a function of the third flowrate; the first flow rate further being controlled as a function of the third feedback value and the second flow rate further being controlled as a function of the fourth feedback value.

7. The method of claim 1, wherein the metal is Magnesium.

8. The method of claim 1, wherein the acid is acetic acid.
